(19) United States
(12) Patent Application Publication
(10) Pub. No.: US 2020/0402734 A1
(43) Pub. Date: Dec. 24, 2020

(54) CAP STRUCTURE AND KEYSWITCH THEREOF

(71) Applicant: DARFON ELECTRONICS CORP., Taoyuan City (TW)

(72) Inventor: Ling-Hsi Chao, Taoyuan City (TW)

(21) Appl. No.: 16/904,552

(22) Filed: Jun. 17, 2020

(30) Foreign Application Priority Data
Jun. 21, 2019 (TW) 108121649

(51) Int. Cl. H01H 3/12; H01H 13/705

(52) U.S. Cl. CPC H01H 3/122; H01H 13/705

(57) ABSTRACT

A cap structure movably connected to first and second support members of a keyswitch is disclosed. The first and second support members are movably connected to a board of the keyswitch. An end portion of the first support member is connected to the cap structure and has a shaft structure. The cap structure includes a cap body, a slot structure, and a limiting structure. A bottom surface of the cap body extends along an X-axis and a Y-axis. The slot structure protrudes from the bottom surface along a Z-axis and has a first slot corresponding to a first end of the shaft structure along the X-axis for allowing the first end to be movably inserted into the first slot. The limiting structure protrudes from the bottom surface along the Z-axis for blocking movement of the shaft structure along the Y-axis to limit the first end in the first slot.

### BACKGROUND OF THE INVENTION

### 1. Field of the Invention

The present invention relates to a cap structure and a keyswitch thereof, and more specifically, to a cap structure utilizing a limiting structure to block movement of a shaft structure of a keyswitch for increasing a pulling force between the cap structure and a support member of the keyswitch and a keyswitch thereof.

### 2. Description of the Prior Art

A keyboard, which is the most common input device, could be found in variety of electronic apparatuses for users to input characters, symbols, numerals and so on. Furthermore, from consumer electronic products to industrial machine tools, they are all equipped with a keyboard for performing input operations.

Please refer to FIG. 1, which is a cross-sectional diagram of a keyswitch 1 according to the prior art. As shown in FIG. 1, the keyswitch 1 includes a board 10, a cap 12, a support device 14, and an elastic member 16. The support device 14 and the elastic member 16 are disposed between the board 10 and the cap 12. The cap 12 has a first sliding slot 11 and a first engaging slot 13, and the board 10 has a second sliding slot 15 and a second engaging slot 17. The support device 14 includes a first support member 19 and a second support member 21. The first support member 19 and the second support member 21 pivotably intersect with each other. The first support member 19 has a first sliding shaft 23 and a first pivot shaft 25. When the first support member 19 is assembled, the first sliding shaft 23 is slidably disposed in the first sliding slot 11, and the first pivot shaft 25 is rotatably pivoted to the second engaging slot 17. The second support member 21 has a second sliding shaft 27 and a second pivot shaft 29. When the second support member 21 is assembled, the second sliding shaft 27 is slidably disposed in the second sliding slot 15, and the second pivot shaft 29 is rotatably pivoted to the first engaging slot 13. In such a manner, the cap 12 can move upward and downward relative to the board 10 via the design that the support device 14 is connected to the cap 12 and the board 10 and the elastic force provided by the elastic member 16.

As shown in FIG. 1, the keyswitch 1 adopts the assembly design that the first sliding shaft 23 of the first support member 19 is slidable in the first sliding slot 11 of the cap 12 for preventing the first sliding shaft 23 from falling off the first sliding slot 11 . In general, the keyswitch 1 usually adopts the design of increasing a slot depth of the first sliding slot 11 for enhancing the pulling force between the cap 12 and the support device 14, so as to make sure that the cap 12 is not easy to fall off the support device 14. However, the aforesaid design may result in excessive assembly resistance between the first sliding shaft 23 and the first sliding slot 11 when the cap 12 is assembled with the support device 14, so as to cause a difficult cap assembly process and the problem that the support device 14 is easily damaged during the cap assembly process. Although the aforesaid problems could be solved by appropriately reducing the slot depth of the first sliding slot 11, it may decrease the pulling force between the cap 12 and the support device 14 to make the cap 12 fall off the support device 14 easily.

### SUMMARY OF THE INVENTION

The present invention provides a cap structure suitable for being movably connected to a first support member and a second support member of a keyswitch. An end portion of the first support member is connected to the cap structure and has at least one shaft structure. The cap structure includes a cap body, a slot structure, and a limiting structure. The cap body has a bottom surface extending along an X-axis and a Y-axis. The X-axis, the Y-axis and a Z-axis are perpendicular to each other. The first support member and the second support member pivotably intersect with each other. The second support member is rotatably connected to the cap body and slidably connected to a board of the keyswitch, and the first support member is rotatably connected to the board, so as to make the cap structure movable upward and downward relative to the board. The slot structure protrudes from the bottom surface along the Z-axis and has a first slot corresponding to a first end of the at least one shaft structure along the X-axis for allowing the first end to be movably inserted into the first slot. The limiting structure protrudes from the bottom surface along the Z-axis to block movement of the at least one shaft structure along the Y-axis for limiting the first end in the first slot. The limiting structure includes a first block. The first block has a second slot formed corresponding to a second end of the at least one shaft structure along the X-axis to allow the second end to be movably inserted into the second slot.

The present invention further provides a cap structure suitable for being movably connected to a first support member and a second support member of a keyswitch. An end portion of the first support member is connected to the cap structure and has at least one shaft structure. The cap structure includes a cap body, a slot structure, and a limiting structure. The cap body has a bottom surface extending along an X-axis and a Y-axis. The X-axis, the Y-axis and a Z-axis are perpendicular to each other. The first support member and the second support member are opposite to each other and are movably connected to each other. The first support member and the second support member are pivoted to a board of the keyswitch respectively, and the second support member are slidably connected to the cap body, so as to make the cap structure movable upward and downward relative to the board. The slot structure protrudes from the bottom surface along the Z-axis and has a first slot corresponding to a first end of the at least one shaft structure along the X-axis for allowing the first end to be movably inserted into the first slot. The limiting structure protrudes from the bottom surface along the Z-axis and extends along the X-axis to block movement of the at least one shaft structure along the Y-axis for limiting the first end in the first slot. The limiting structure has an avoiding surface facing a second end of the at least one shaft structure. The avoiding surface matches with the second end along a motion track of the first support member to be spaced apart from the second end at a predetermined gap when the cap structure moves upward and downward relative to the board.

The present invention further provides a cap structure suitable for being movably connected to a first support member and a second support member of a keyswitch. An end portion of the first support member is connected to the cap structure and has at least one shaft structure. The cap structure includes a cap body, a slot structure, and a limiting structure. The cap body has a bottom surface extending along an X-axis and a Y-axis. The X-axis, the Y-axis and a Z-axis are perpendicular to each other. The first support member and the second support member are opposite to each other and are movably connected to each other. The first support member and the second support member are pivoted to a board of the keyswitch respectively, and the second support member being slidably connected to the cap body, so as to make the cap structure movable upward and downward relative to the board. The slot structure protrudes from the bottom surface along the Z-axis and has a first slot corresponding to a first end of the at least one shaft structure along the X-axis for allowing the first end to be movably inserted into the first slot. The limiting structure protrudes from the bottom surface along the Z-axis to block movement of the at least one shaft structure along the Y-axis for limiting the first end in the first slot. The limiting structure includes a first block and a second block. The first block and the second block extend along the X-axis and are located at two sides of the second end to block movement of the second end along the X-axis for making the at least one shaft structure pivoted to the slot structure and the limiting structure.

The present invention further provides a keyswitch. The keyswitch includes a board, a first support member, a second support member, and a cap structure. The first support member is rotatably connected to the board. The second support member is movably connected to the board. The first support member and the second support member pivotably intersect with each other. The cap structure is movable upward and downward relative to the board. An end portion of the first support member is connected to the cap structure and has at least one shaft structure. The cap structure includes a cap body, a slot structure, and a limiting structure. The cap body has a bottom surface extending along an X-axis and a Y-axis. The X-axis, the Y-axis and a Z-axis are perpendicular to each other. The second support member is rotatably connected to the cap body and slidably connected to the board. The slot structure protrudes from the bottom surface along the Z-axis and has a first slot corresponding to a first end of the at least one shaft structure along the X-axis for allowing the first end to be movably inserted into the first slot. The limiting structure protrudes from the bottom surface along the Z-axis to block movement of the at least one shaft structure along the Y-axis for limiting the first end in the first slot. The limiting structure includes a first block. The first block has a second slot formed corresponding to a second end of the at least one shaft structure along the X-axis to allow the second end to be movably inserted into the second slot.

The present invention further provides a keyswitch. The keyswitch includes a board, a first support member, a second support member and a cap body. The first support member is pivoted to the board. The second support member is pivoted to the board. The first support member and the second support member are opposite to each other and movably connected to each other. The cap structure is movably connected to the first support member and the second support member to be movable upward and downward relative to the board. An end portion of the first support member is connected to the cap structure and has at least one shaft structure. The cap structure includes a cap body, a slot structure, and a limiting structure. The cap body has a bottom surface extending along an X-axis and a Y-axis. The X-axis, the Y-axis and a Z-axis are perpendicular to each other. The second support member is slidably connected to the cap body. The slot structure protrudes from the bottom surface along the Z-axis and has a first slot corresponding to a first end of the at least one shaft structure along the X-axis for allowing the first end to be movably inserted into the first slot. The limiting structure protrudes from the bottom surface along the Z-axis and extends along the X-axis to block movement of the at least one shaft structure along the Y-axis for limiting the first end in the first slot. The limiting structure has an avoiding surface facing a second end of the at least one shaft structure. The avoiding surface matches with the second end along a motion track of the first support member to be spaced apart from the second end at a predetermined gap when the cap structure moves upward and downward relative to the board.

The present invention further provides a keyswitch. The keyswitch includes a board, a first support member, a second support member, and a cap structure. The first support member is pivoted to the board. The second support member is pivoted to the board. The first support member and the second support member are opposite to each other and movably connected to each other. The cap structure is movably connected to the first support member and the second support member to be movable upward and downward relative to the board. An end portion of the first support member is connected to the cap structure and has at least one shaft structure. The cap structure includes a cap body, a slot structure, and a limiting structure. The cap body has a bottom surface extending along an X-axis and a Y-axis. The X-axis, the Y-axis and a Z-axis are perpendicular to each other. The second support member is slidably connected to the cap body. The slot structure protrudes from the bottom surface along the Z-axis and has a first slot corresponding to a first end of the at least one shaft structure along the X-axis for allowing the first end to be movably inserted into the first slot. The limiting structure protrudes from the bottom surface along the Z-axis to block movement of the at least one shaft structure along the Y-axis for limiting the first end in the first slot. The limiting structure includes a first block and a second block. The first block and the second block extend along the X-axis and are located at two sides of the second end to block movement of the second end along the X-axis for making the at least one shaft structure pivoted to the slot structure and the limiting structure.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a cross-sectional diagram of a keyswitch according to the prior art.

FIG. 2 is a partial exploded diagram of a keyswitch according to an embodiment of the present invention.

FIG. 3 is a partial enlarged diagram of a cap structure in FIG. 2 at another viewing angle.

FIG. 4 is a partial enlarged top view of the keyswitch in FIG. 2 when the cap structure is assembled with a board.

FIG. 5 is a partial exploded diagram of a keyswitch according to another embodiment of the present invention.

FIG. 6 is a partial enlarged diagram of a cap structure in FIG. 5 at another viewing angle.

FIG. 7 is a partial enlarged top view of the keyswitch in FIG. 5 when the cap structure is assembled with the board.

FIG. 8 is a partial enlarged top view of a keyswitch according to another embodiment of the present invention.

FIG. 9 is a partial exploded diagram of a keyswitch according to an embodiment of the present invention.

FIG. 10 is a partial enlarged diagram of a cap structure in FIG. 9.

FIG. 11 is a cross-sectional diagram of the keyswitch in FIG. 9 along a cross-sectional line A-A when the cap structure is assembled with the board.

FIG. 12 is a partial exploded diagram of a keyswitch according to another embodiment of the present invention.

FIG. 13 is a partial enlarged diagram of a cap structure in FIG. 12 at another viewing angle.

FIG. 14 is a partial enlarged top view of the keyswitch in FIG. 12 when the cap structure is assembled with the board.

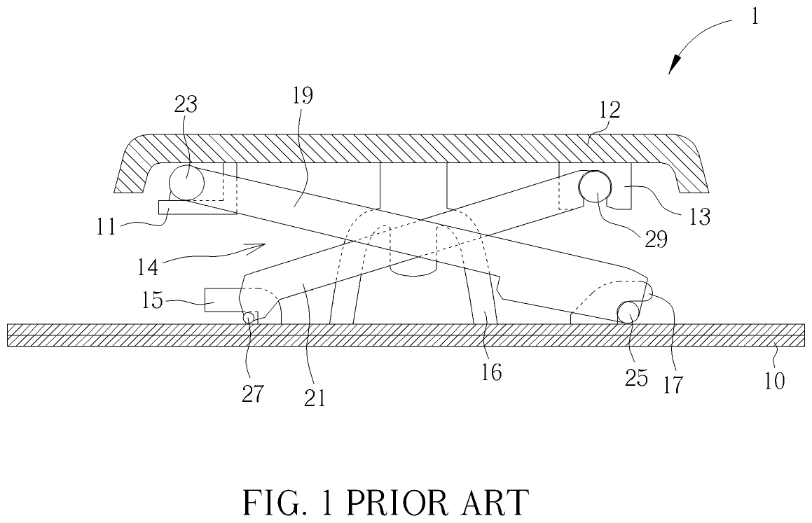

### DETAILED DESCRIPTION

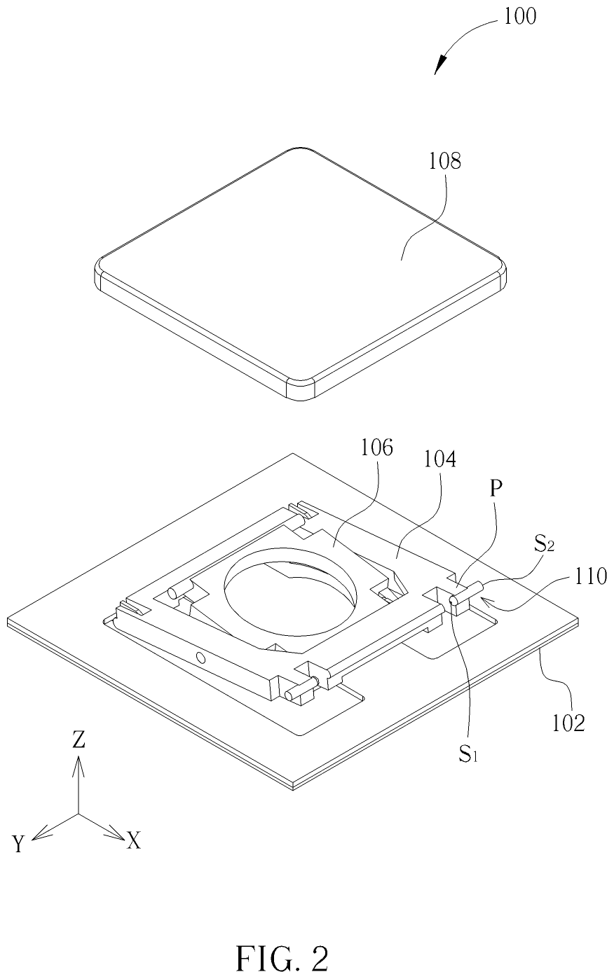

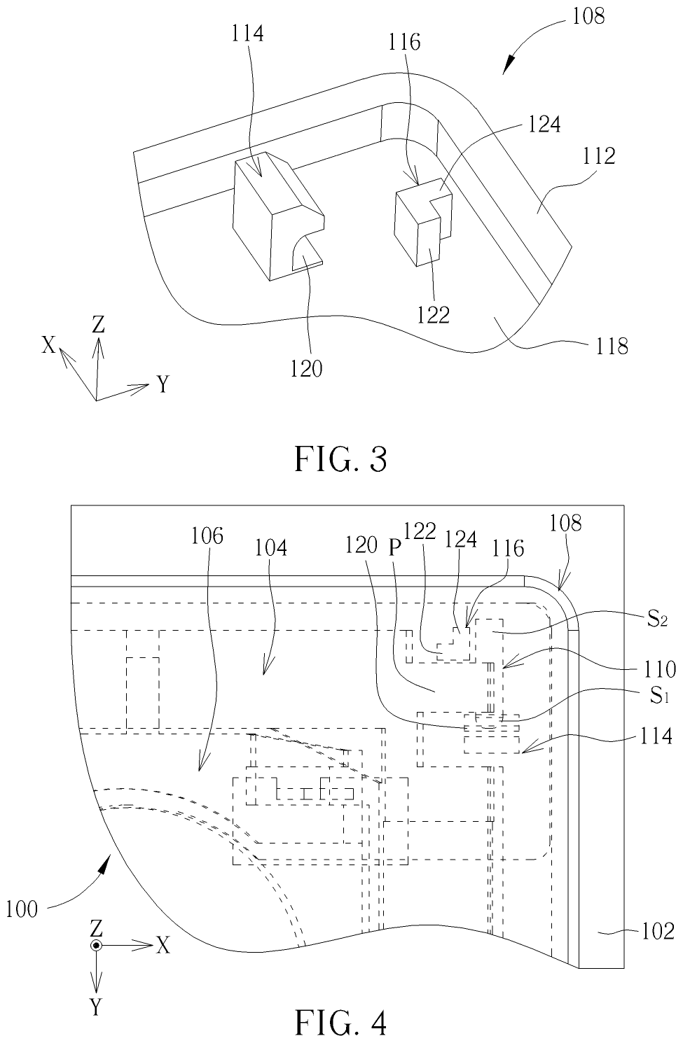

Please refer to FIG. 2, FIG. 3, and FIG. 4. FIG. 2 is a partial exploded diagram of a keyswitch 100 according to an embodiment of the present invention. FIG. 3 is a partial enlarged diagram of a cap structure 108 in FIG. 2 at another viewing angle. FIG. 4 is a partial enlarged top view of the keyswitch 100 in FIG. 2 when the cap structure 108 is assembled with a board 102. As shown in FIG. 2, FIG. 3, and FIG. 4, the keyswitch 100 includes the board 102, a first support member 104, a second support member 106, and the cap structure 108. The first support member 104 and the second support member 106 are movably connected to the board 102 and the cap structure 108. In this embodiment, the keyswitch 100 could preferably adopt a scissor support structural design commonly applied to a keyswitch of a keyboard. That is, the first support member 104 pivotably intersects with the second support member 106 and is pivotably connected to the board 102, and the second support member 106 is pivotably connected to the cap structure 108 and slidably connected to the board 102. Accordingly, via pivotal movement of the first support member 104 and the second support member 106, the cap structure 108 can move upward and downward relative to the board 102 for a user to perform input operations. As for the related description for the connection design that the first support member 104 is pivoted to the board 102 and the connection design that the second support member 106 is pivoted to the cap structure 108 and slidably connected to the board 102 (e.g. the first support member 104 and the second support member 106 could have pivot shafts to be pivoted to the board 102 and the cap structure 108 respectively) , it could be reasoned by analogy according to the prior art and omitted herein.

More detailed description for the sliding design of the cap structure 108 and the first support member 104 is provided as follows. As shown in FIGS. 2-4, an end portion P of the first support member 104 is connected to the cap structure 108 and has at least one shaft structure 110 (only one shown in FIG. 4, but not limited thereto). The cap structure 108 includes a cap body 112, a slot structure 114, and a limiting structure 116. The cap body 112 has a bottom surface 118. The bottom surface 118 extends along an X-axis and a Y-axis as shown in FIG. 3, and the X-axis, the Y-axis and a Z-axis are perpendicular to each other. The slot structure 114 protrudes from the bottom surface 118 along the Z-axis and has a first slot 120 corresponding to a first end S₁ of the shaft structure 110 along the X-axis for allowing the first end S₁ to be movably inserted into the first slot 120, so that the first support member 104 can be slidably connected to the cap structure 108. The limiting structure 116 protrudes from the bottom surface 118 along the Z-axis to block movement of the shaft structure 110 along the Y-axis for limiting the first end S₁ in the first slot 120. To be more specific, in this embodiment, the limiting structure 116 could include a first block 122. The first block 122 extends along the X-axis to block movement of the shaft structure 110 along the Y-axis. Furthermore, in practical application, the limiting structure 110 could further include a second block 124. The second block 124 extends from the first block 122 along the Y-axis to block inward movement of a second end S₂ of the shaft structure 110 along the X-axis.

In such a manner, via the design of utilizing the first block 122 to block movement of the shaft structure 110 along the Y-axis and utilizing the second block 124 to block inward movement of the shaft structure 110 along the X-axis for increasing the pulling force between first support member 104 and the cap structure 108, the present invention can surely prevent the first end S₁ of the shaft structure 110 from falling out of the first slot 120 accidentally when deformation of the cap structure 108 occurs (e.g. when the user pulls a corner of the cap structure 108 corresponding to the shaft structure 110) . As such, the shaft structure 110 can be limited between the slot structure 114 and the limiting structure 116 steadily, so as to efficiently solve the prior art problem that the cap is easy to fall off.

Furthermore, since the cap structure 108 only utilizes the limiting structure 116 to prevent the shaft structure 110 from falling off the first slot 120 without increasing a slot depth of the first slot 120 to enhance the pulling force between the first support member 104 and the cap structure 108, the slot depth of the first slot 120 can be further reduced (accordingly, the structural thickness of the slot structure 114 can be increased to enhance the pulling force between the first support member 104 and the cap structure 108), so that the user can press the shaft structure 110 of the first support member 104 vertically into the first slot 120 of the cap structure 108 effortlessly.

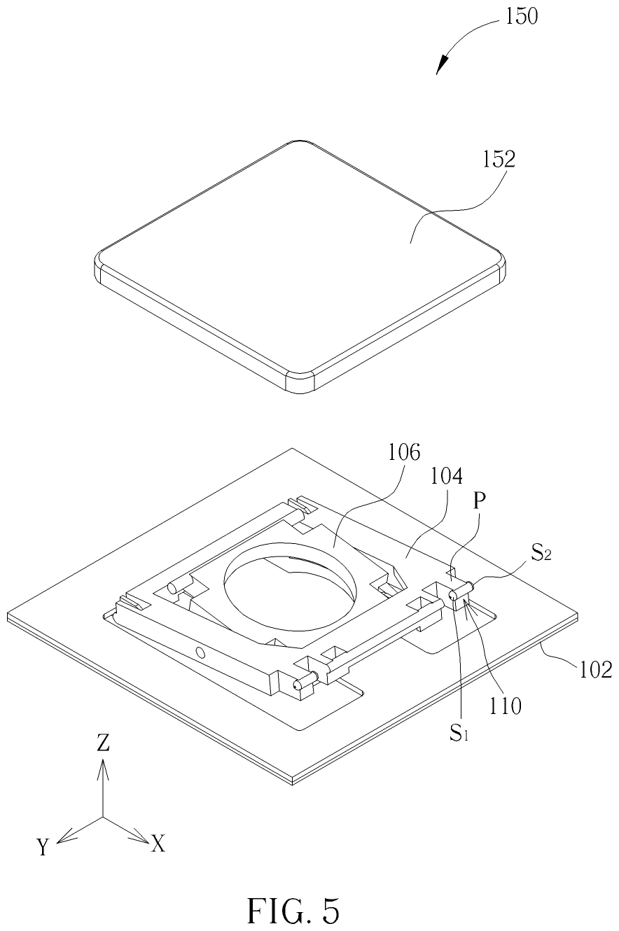

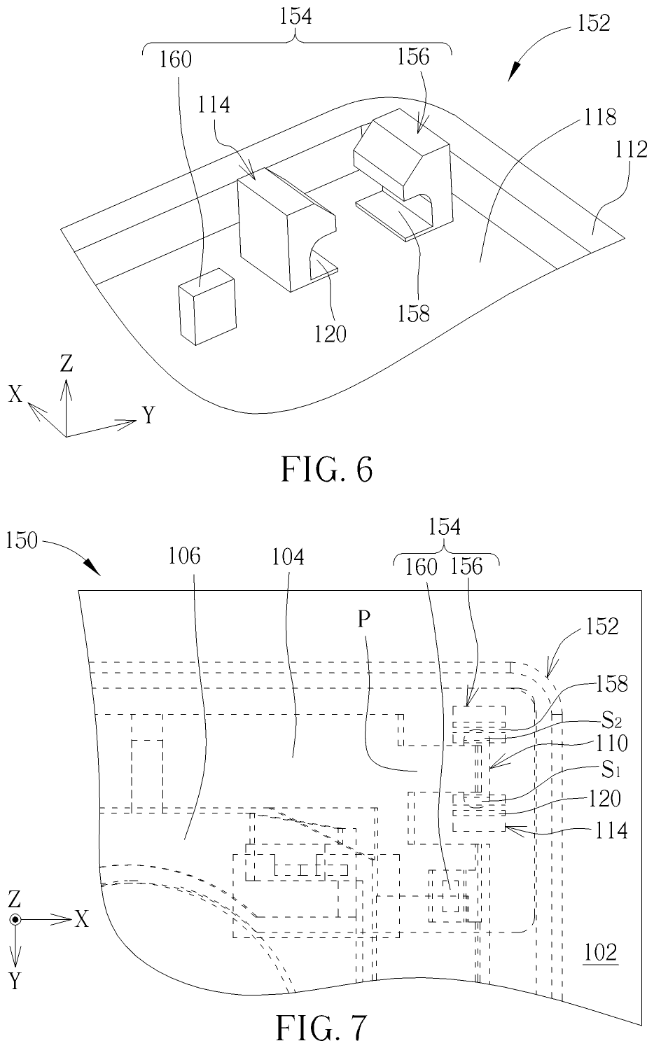

The sliding design of the cap structure and the first support member is not limited to the aforesaid embodiment. For example, please refer to FIG. 5, FIG. 6, and FIG. 7. FIG. 5 is a partial exploded diagram of a keyswitch 150 according to another embodiment of the present invention. FIG. 6 is a partial enlarged diagram of a cap structure 152 in FIG. 5 at another viewing angle. FIG. 7 is a partial enlarged top view of the keyswitch 150 in FIG. 5 when the cap structure 152 is assembled with the board 102. Components both mentioned in this embodiment and the aforesaid embodiment represent components with similar structures or functions, and the related description is omitted herein. As shown in FIG. 5, FIG. 6, and FIG. 7, the keyswitch 150 includes the board 102, the first support member 104, the second support member 106, and the cap structure 152. The end portion P of the first support member 104 is connected to the cap structure 152 and has the shaft structure 110. The cap structure 152 includes the cap body 112, the slot structure 114, and a limiting structure 154. In this embodiment, the limiting structure 154 could include a first block 156. The first block 156 has a second slot 158 formed corresponding to the second end S₂ of the shaft structure 110 along the X-axis for allowing the second end S₂ movably inserted into the second slot 158. Accordingly, the first support member 104 can be slidably connected to the cap structure 108 via the sliding design of the first end S₁ and the first slot 120 and the sliding design of the second end S₂ and the second slot 158. In practical application, the limiting structure 152 could include a second block 160. The second block 160 extends along the Y-axis to block inward movement of the shaft structure 110 along the X-axis for limiting the first end S₁ and the second end S₂ in the first slot 120 and the second slot 158 respectively.

In such a manner, via the design of utilizing the second slot 158 to block movement of the shaft structure 110 along the Y-axis and utilizing the second block 160 to block inward movement of the shaft structure 110 along the X-axis for increasing the pulling force between first support member 104 and the cap structure 152, the present invention can surely prevent the shaft structure 110 from falling out of the first slot 120 and the second slot 158 accidentally when deformation of the cap structure 152 occurs (e.g. when the user pulls a corner of the cap structure 152 corresponding to the shaft structure 110) . As such, the shaft structure 110 can be limited between the slot structure 114 and the limiting structure 154 steadily, so as to efficiently solve the prior art problem that the cap is easy to fall off.

Moreover, since the cap structure 152 adopts the design of utilizing the first slot 120 and the second slot 158 to increase the pulling force between the first support member 104 and the cap structure 152 without adjusting the slot depth of the first slot 120, the slot depths of the first slot 120 and the second slot 158 can be further reduced (accordingly, the structural thickness of the slot structure 114 and the first block 156 can be increased for enhancing the pulling force between the first support member 104 and the cap structure 152) , so that the user can press the shaft structure 110 of the first support member 104 vertically into the first slot 120 and the second slot 158 of the cap structure 152 effortlessly.

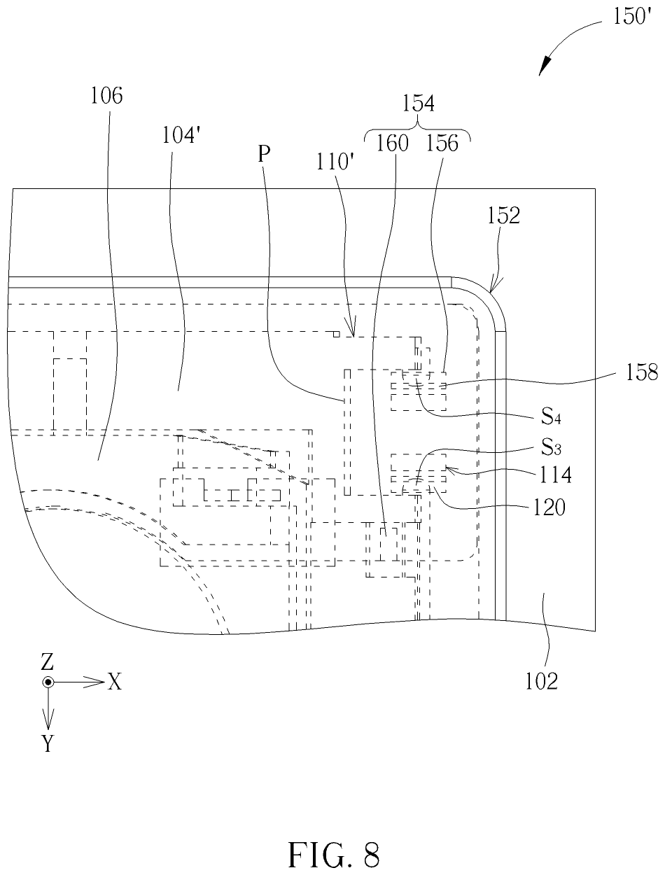

To be noted, the sliding design of the slot of the slot structure and the shaft end of the shaft structure adopted by the present invention is not limited to the aforesaid embodiments, meaning that the present invention could adopt the design that the slot and the shaft end swap their positions. For example, please refer to FIG. 8, which is a partial enlarged top view of a keyswitch 150′ according to another embodiment of the present invention. Components both mentioned in this embodiment and the aforesaid embodiments represent components with similar structures or functions, and the related description is omitted herein. As shown in FIG. 8, the keyswitch 150′ includes the board 102, a first support member 104′, the second support member 106, and the cap structure 152. In this embodiment, the end portion P of the first support member 104′ is connected to the cap structure 152 and has at least one shaft structure 110′ (only one shown in FIG. 8, but not limited thereto). A first end S₃ and a second end S₄ of the shaft structure 110′ are slidably inserted into the first slot 120 and the second slot 158, so that the first support member 104′ can be slidably connected to the cap structure 152 via sliding of the first end S₃ in the first slot 120 and sliding of the second end S₄ in the second slot 158. As for the other related description for the keyswitch 150′, it could be reasoned by analogy according to the aforesaid embodiments and omitted herein.

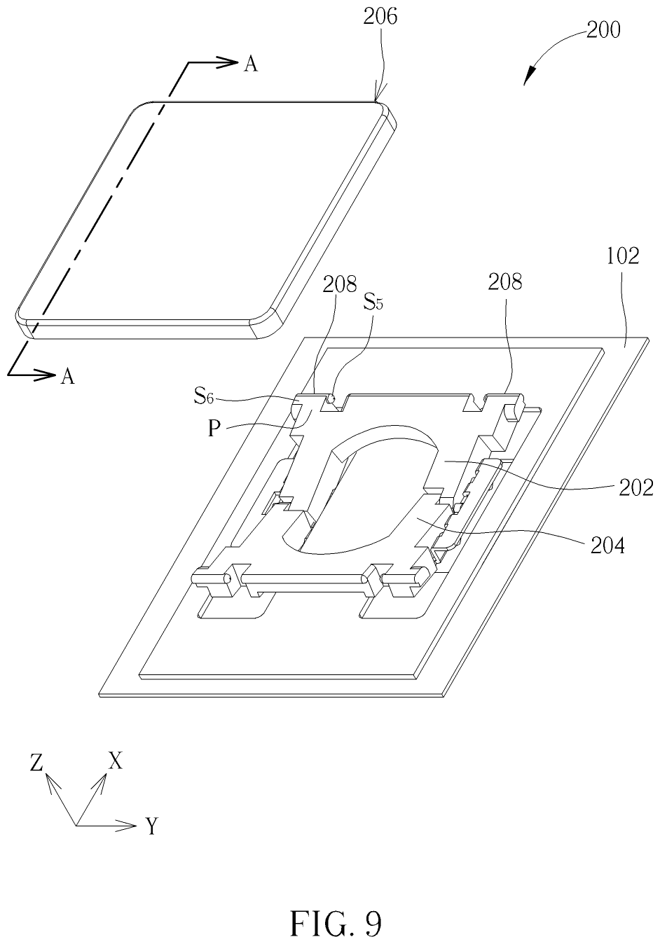

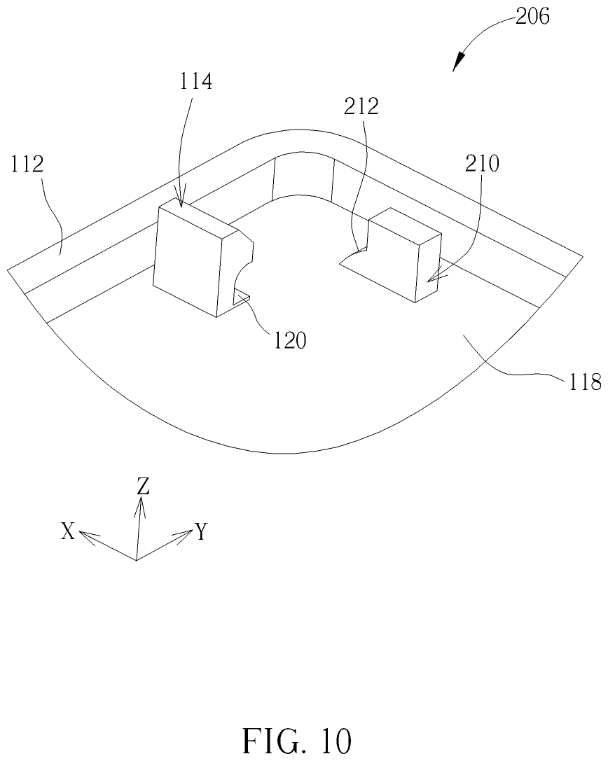

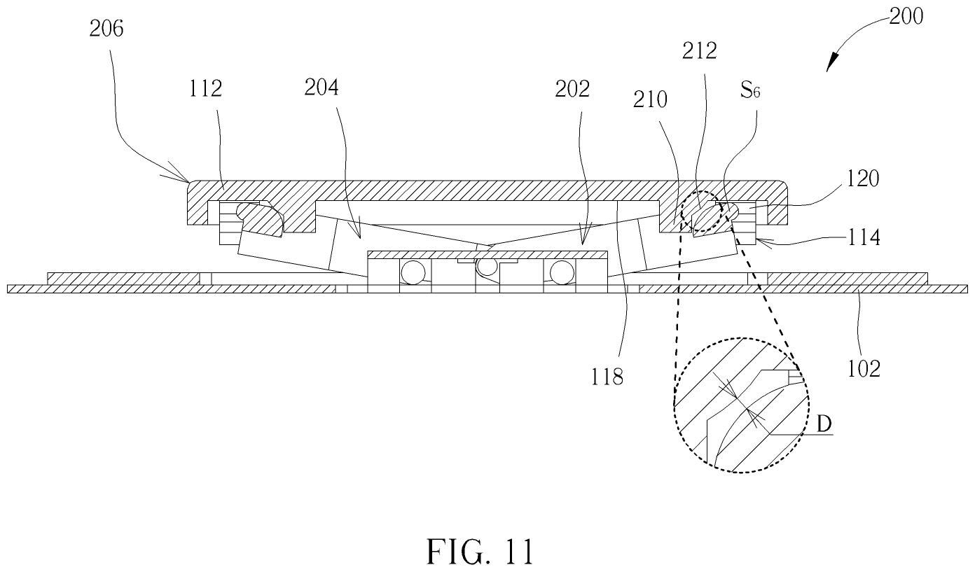

Please refer to FIG. 9, FIG. 10 and FIG. 11. FIG. 9 is a partial exploded diagram of a keyswitch 200 according to an embodiment of the present invention. FIG. 10 is a partial enlarged diagram of a cap structure 206 in FIG. 9. FIG. 11 is a cross-sectional diagram of the keyswitch 200 in FIG. 9 along a cross-sectional line A-A when the cap structure 206 is assembled with the board 102. Components both mentioned in this embodiment and the aforesaid embodiment represent components with similar structures or functions, and the related description is omitted herein.

As shown in FIG. 9, FIG. 10, and FIG. 11, the keyswitch 200 includes the board 102, a first support member 202, a second support member 204, and a cap structure 206. The first support member 202 and the second support member 204 are movably connected to the board 102 and the cap structure 206. In this embodiment, the keyswitch 200 could adopt a butterfly support structural design commonly applied to a keyswitch of a keyboard. That is, the first support member 202 and the second support member 204 are opposite to each other and are movably connected to each other. Furthermore, the first support member 202 and the second support member 204 are pivoted to the board 102 respectively (as shown in FIG. 11) and are slidably connected to the cap structure 206. Accordingly, the cap structure 206 can move upward and downward relative to the board 102 for a user to perform input operations. As for the related description for the connection design that the first support member 202 and the second support member 204 are movably connected to each other and are pivoted to the board 102 respectively (e.g. the first support member 202 and the second support member 204 could have pivot shafts to be pivoted to the board 102 respectively), it could be reasoned by analogy according to the prior art and omitted herein.

More detailed description for the sliding design of the cap structure 206 and the first support member 202 is provided as follows, and the related description for the sliding design of the cap structure 206 and the second support member 204 could be reasoned by analogy according to the following description. As shown in FIGS. 9-11, the end portion P of the shaft structure 202 is connected to the cap structure 206 and has at least one shaft structure 208 (two shown in FIG. 9, but not limited thereto) . The cap structure 206 includes the cap body 112, the slot structure 114, and a limiting structure 210. The slot structure 114 protrudes from the bottom surface 118 along the Z-axis and has the first slot 120 corresponding to a first end S₅ of the shaft structure 208 along the X-axis for allowing the first end S₅ to be movably inserted into the first slot 120. The limiting structure 210 protrudes from the bottom surface 118 along the Z-axis to block movement of the shaft structure 208 along the Y-axis for limiting the first end S₅ in the first slot 120.

To be more specific, in this embodiment, the limiting structure 210 has an avoiding surface 212 facing a second end S₆ of the shaft structure 208. The avoiding surface 212 matches with the second end S₆ along a motion track of the first support member 202, so as to make the cap structure 206 spaced apart from the second end S₆ at a predetermined gap D when the cap structure 206 moves upward and downward relative to the board 102. The predetermined gap D could be preferably between 0.02 mm and 0.05 mm or between 0.05 mm and 0.15 mm (but not limited thereto). Accordingly, during upward and downward movement of the cap structure 206, the limiting structure 210 can be spaced apart from the first support member 202 for improving motion smoothness of the cap structure 206, meaning that the aforesaid gap can inhibit or prevent abrasion between the cap structure 206 and the first support member 202. As for the other related description for the keyswitch 200, it could be reasoned by analogy according to the aforesaid embodiments and omitted herein.

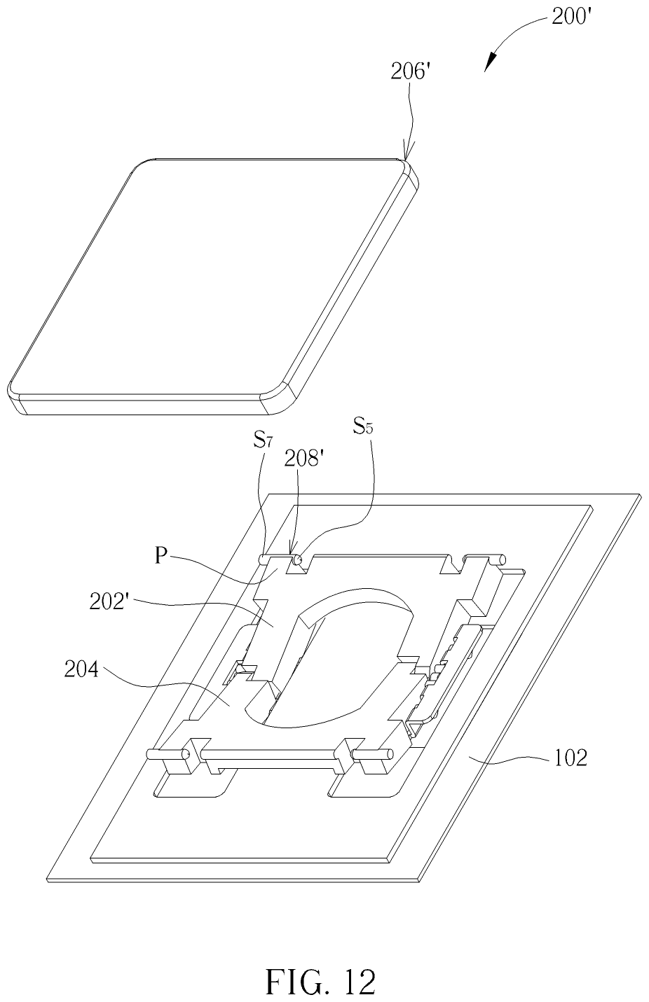

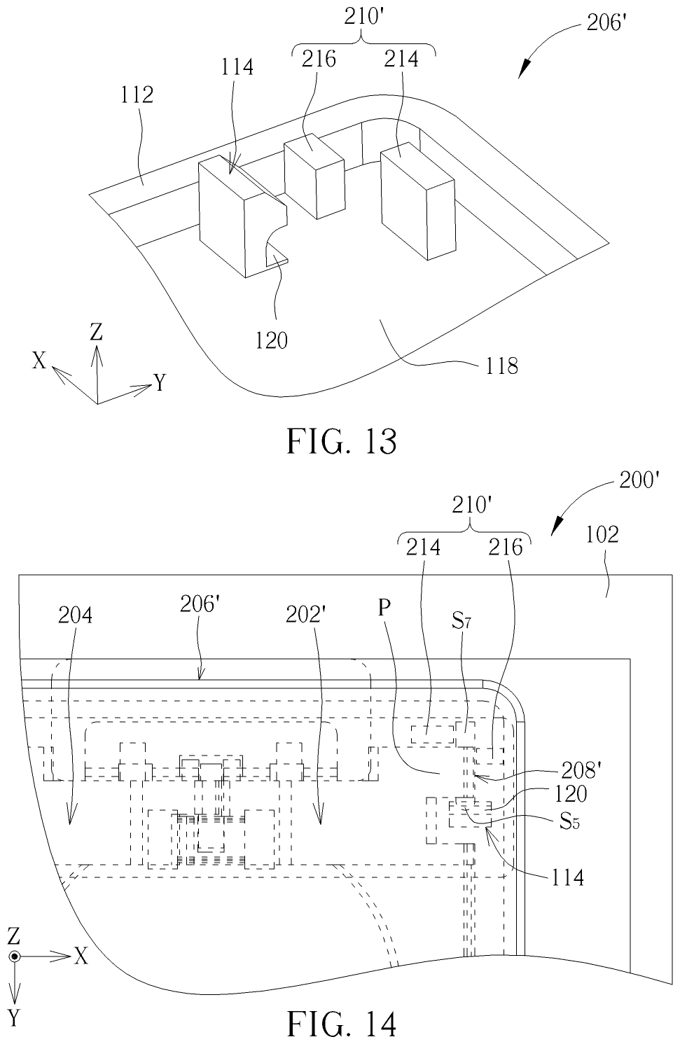

It should be mentioned that the connection design of the cap structure and the first support member is not limited to the aforesaid sliding designs, meaning that the present invention could adopt the pivotal connection design in another embodiment. For example, please refer to FIG. 12, FIG. 13, and FIG. 14. FIG. 12 is a partial exploded diagram of a keyswitch 200′ according to another embodiment of the present invention. FIG. 13 is a partial enlarged diagram of a cap structure 206′ in FIG. 12 at another viewing angle. FIG. 14 is a partial enlarged top view of the keyswitch 200′ in FIG. 12 when the cap structure 206′ is assembled with the board 102. Components both mentioned in this embodiment and the aforesaid embodiment represent components with similar structures or functions, and the related description is omitted herein. As shown in FIG. 12. FIG. 13, and FIG. 14, the keyswitch 200′ includes the board 102, a first support member 202′, the second support member 204, and a cap structure 206′. The first support member 202′ and the second support member 204 are opposite to each other and are movably connected to each other. The first support member 202′ is pivoted to the board 102 and the end portion P of the first support member 202′ is connected to the cap structure 206′ and has at least one shaft structure 208′ (one shown in FIG. 14, but not limited thereto). The cap structure 206′ includes the cap body 112, the slot structure 114, and a limiting structure 210′. In this embodiment, the limiting structure 210′ includes a first block 214 and a second block 216. The first block 214 and the second block 216 extend along the X-axis and are located at two sides of a second end S₇ of the shaft structure 208′ to block movement of the second S₇ along the X-axis, so as to make the shaft structure 208′ pivoted to the slot structure 114 and the limiting structure 210′. As for the other related description for the keyswitch 200′, it could be reasoned by analogy according to the aforesaid embodiments and omitted herein.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A cap structure suitable for being movably connected to a first support member and a second support member of a keyswitch, an end portion of the first support member being connected to the cap structure and having at least one shaft structure, the cap structure comprising:
a cap body having a bottom surface extending along an X-axis and a Y-axis, the X-axis, the Y-axis and a Z-axis being perpendicular to each other, the first support member and the second support member pivotably intersecting with each other, the second support member being rotatably connected to the cap body and slidably connected to a board of the keyswitch and the first support member being rotatably connected to the board, so as to make the cap structure movable upward and downward relative to the board;
a slot structure protruding from the bottom surface along the Z-axis and having a first slot corresponding to a first end of the at least one shaft structure along the X-axis for allowing the first end to be movably inserted into the first slot; and
a limiting structure protruding from the bottom surface along the Z-axis to block movement of the at least one shaft structure along the Y-axis for limiting the first end in the first slot, the limiting structure comprising a first block, the first block having a second slot formed corresponding to a second end of the at least one shaft structure along the X-axis to allow the second end to be movably inserted into the second slot.

2. The cap structure of claim 1, wherein the limiting structure further comprises a second block, the second block extends along the Y-axis to block inward movement of the at least one shaft structure along the X-axis for limiting the first end and the second end in the first slot and the second slot respectively.

3. A cap structure suitable for being movably connected to a first support member and a second support member of a keyswitch, an end portion of the first support member being connected to the cap structure and having at least one shaft structure, the cap structure comprising:
a cap body having a bottom surface extending along an X-axis and a Y-axis, the X-axis, the Y-axis and a Z-axis being perpendicular to each other, the first support member and the second support member being opposite to each other and being movably connected to each other, the first support member and the second support member being pivoted to a board of the keyswitch respectively and the second support member being slidably connected to the cap body, so as to make the cap structure movable upward and downward relative to the board;
a slot structure protruding from the bottom surface along the Z-axis and having a first slot corresponding to a first end of the at least one shaft structure along the X-axis for allowing the first end to be movably inserted into the first slot; and
a limiting structure protruding from the bottom surface along the Z-axis and extending along the X-axis to block movement of the at least one shaft structure along the Y-axis for limiting the first end in the first slot, the limiting structure having an avoiding surface facing a second end of the at least one shaft structure, the avoiding surface matching with the second end along a motion track of the first support member to be spaced apart from the second end at a predetermined gap when the cap structure moves upward and downward relative to the board.

4. The cap structure of claim 3, wherein the predetermined gap is between 0.02 mm and 0.05 mm or between 0.05 m and 0.15 mm.

5. A cap structure suitable for being movably connected to a first support member and a second support member of a keyswitch, an end portion of the first support member being connected to the cap structure and having at least one shaft structure, the cap structure comprising:
a cap body having a bottom surface extending along an X-axis and a Y-axis, the X-axis, the Y-axis and a Z-axis being perpendicular to each other, the first support member and the second support member being opposite to each other and being movably connected to each other, the first support member and the second support member being pivoted to a board of the keyswitch respectively and the second support member being slidably connected to the cap body, so as to make the cap structure movable upward and downward relative to the board;
a slot structure protruding from the bottom surface along the Z-axis and having a first slot corresponding to a first end of the at least one shaft structure along the X-axis for allowing the first end to be movably inserted into the first slot; and
a limiting structure protruding from the bottom surface along the Z-axis to block movement of the at least one shaft structure along the Y-axis for limiting the first end in the first slot, the limiting structure comprising a first block and a second block, the first block and the second block extending along the X-axis and being located at two sides of the second end to block movement of the second end along the X-axis for making the at least one shaft structure pivoted to the slot structure and the limiting structure.

6. A keyswitch comprising:
a board;
a first support member rotatably connected to the board;
a second support member movably connected to the board, the first support member and the second support member pivotably intersecting with each other; and
a cap structure movable upward and downward relative to the board, an end portion of the first support member being connected to the cap structure and having at least one shaft structure, the cap structure comprising:
a cap body having a bottom surface extending along an X-axis and a Y-axis, the X-axis, the Y-axis and a Z-axis being perpendicular to each other, the second support member being rotatably connected to the cap body and slidably connected to the board;
a slot structure protruding from the bottom surface along the Z-axis and having a first slot corresponding to a first end of the at least one shaft structure along the X-axis for allowing the first end to be movably inserted into the first slot; and
a limiting structure protruding from the bottom surface along the Z-axis to block movement of the at least one shaft structure along the Y-axis for limiting the first end in the first slot, the limiting structure comprising a first block, the first block having a second slot formed corresponding to a second end of the at least one shaft structure along the X-axis to allow the second end to be movably inserted into the second slot.

7. The keyswitch of claim 6, wherein the limiting structure further comprises a second block, the second block extends along the Y-axis to block inward movement of the at least one shaft structure along the X-axis for limiting the first end and the second end in the first slot and the second slot respectively.

8. A keyswitch comprising:
a board;
a first support member pivoted to the board;
a second support member pivoted to the board, the first support member and the second support member being opposite to each other and movably connected to each other; and
a cap structure movably connected to the first support member and the second support member to be movable upward and downward relative to the board, an end portion of the first support member being connected to the cap structure and having at least one shaft structure, the cap structure comprising:
a cap body having a bottom surface extending along an X-axis and a Y-axis, the X-axis, the Y-axis and a Z-axis being perpendicular to each other, the second support member being slidably connected to the cap body;
a slot structure protruding from the bottom surface along the Z-axis and having a first slot corresponding to a first end of the at least one shaft structure along the X-axis for allowing the first end to be movably inserted into the first slot; and
a limiting structure protruding from the bottom surface along the Z-axis and extending along the X-axis to block movement of the at least one shaft structure along the Y-axis for limiting the first end in the first slot, the limiting structure having an avoiding surface facing a second end of the at least one shaft structure, the avoiding surface matching with the second end along a motion track of the first support member to be spaced apart from the second end at a predetermined gap when the cap structure moves upward and downward relative to the board.

9. The keyswitch of claim 8, wherein the predetermined gap is between 0.02 mm and 0.05 mm or between 0.05 m and 0.15 mm.

10. A keyswitch comprising:
a board;
a first support member pivoted to the board;
a second support member pivoted to the board, the first support member and the second support member being opposite to each other and movably connected to each other; and
a cap structure movably connected to the first support member and the second support member to be movable upward and downward relative to the board, an end portion of the first support member being connected to the cap structure and having at least one shaft structure, the cap structure comprising:
a cap body having a bottom surface extending along an X-axis and a Y-axis, the X-axis, the Y-axis and a Z-axis being perpendicular to each other, the second support member being slidably connected to the cap body;
a slot structure protruding from the bottom surface along the Z-axis and having a first slot corresponding to a first end of the at least one shaft structure along the X-axis for allowing the first end to be movably inserted into the first slot; and
a limiting structure protruding from the bottom surface along the Z-axis to block movement of the at least one shaft structure along the Y-axis for limiting the first end in the first slot, the limiting structure comprising a first block and a second block, the first block and the second block extending along the X-axis and being located at two sides of the second end to block movement of the second end along the X-axis for making the at least one shaft structure pivoted to the slot structure and the limiting structure.
